(19) United States
(12) Patent Application Publication
(10) Pub. No.: US 2018/0284302 A1
(43) Pub. Date: Oct. 4, 2018

(54) AERIAL CDZNTE INSPECTION SYSTEM AND INSPECTION METHOD

(71) Applicant: NUCTECH COMPANY LIMITED, Beijing (CN)

(72) Inventors: Lan ZHANG, Beijing (CN); Weizhi WANG, Beijing (CN); Yingshuai DU, Beijing (CN); Zonggui WU, Beijing (CN); Wei ZHANG, Beijing (CN); Xuming MA, Beijing (CN); Kun ZHAO, Beijing (CN); Jun LI, Beijing (CN)

(21) Appl. No.: 15/740,813

(22) PCT Filed: Aug. 23, 2016
(86) PCT No.: PCT/CN2016/096346

§ 371 Date: Dec. 29, 2017

(30) Foreign Application Priority Data
Dec. 24, 2015 (CN) 201510983070.8

(51) Int. Cl. G01T 1/36; G05D 1/04; G05D 1/02; G01N 21/17

(52) U.S. Cl. CPC G01T 1/36; G05D 1/042; G01N 2201/0214; G01N 21/17; G01N 2021/177; G05D 1/0202

(57) ABSTRACT

The present invention relates to the field of radiation detection, and provides a CdZnTe aerial inspection system and an inspection method. The inspection system comprises a CdZnTe spectrometer (10) and an aircraft (20). The aircraft (20) flies and carries the CdZnTe spectrometer (10) to realize a function of aerial inspection, thereby improving operating efficiency of nuclear radiation monitoring. The CdZnTe spectrometer (10) has high energy resolution, a small volume, a light weight, and desirable portability. By combining the CdZnTe spectrometer (10) and the aircraft (20), the present invention enables high measurement precision, a long operation duration, and an aerial access to a site of a nuclear accident to perform operations and inspect the site, thus reducing radiation exposure received by a person entering the site, and providing support for rescue operation.

### TECHNICAL FIELD

This disclosure relates to the field of radiation detection, in particular to an aerial CdZnTe (cadmium zinc telluride) inspection system and an aerial CdZnTe inspection method.

### BACKGROUND

According to traditional means of nuclear radiation monitoring, operators carrying detection equipment must enter into a radioactive pollution area to monitor a gamma-ray dose rate and identify nuclides. When operating from one location to another location, operators must carry the detection equipment and work long hours with low efficiency, increasing the amount of radiation dose the operator receives. It has been proofed that nuclear radiation monitoring is difficult in some places, such as in serious radioactive contamination, with bumpy ground, or radioactively contaminated buildings that are damaged or high buildings. In order to protect the personal safety of operators, it is necessary to shorten the duration of each operation, so that work efficiency is reduced.

### SUMMARY

A technical problem to be solved by the present application is: to improve the efficiency of nuclear radiation monitoring.

According to a first aspect of this disclosure, an aerial CdZnTe inspection system is provided, comprising: a CdZnTe spectrometer and an aircraft, wherein the aircraft flies with the CdZnTe spectrometer to perform aerial inspection.

The inspection system further comprises a workstation system for receiving the energy spectrum information from the CdZnTe spectrometer and determining radiation conditions by analyzing the energy spectrum information, for example, identifying nuclides, determining the type and intensity of a radioactive material, calculating a dose rate of the radiation and so on. The CdZnTe spectrometer is used for detecting rays, collecting an energy spectrum and transmitting energy spectrum information.

In one embodiment, the aircraft is used for acquiring at least one of navigation information, altitude information, a video image of an inspection area of the aircraft itself, and transmitting the information to the workstation system; the workstation system is used for drawing a three-dimensional radioactive material distribution profile and dose distribution profile according to the navigation information and altitude information from the aircraft and the energy spectrum information from the CdZnTe spectrometer, and overlaying the three-dimensional radioactive distribution profile material and dose distribution profile on the video image of the inspection area.

The CdZnTe spectrometer comprises: a CdZnTe crystal for converting incident gamma rays into an electrical signal; an amplifier for processing the electrical signal to produce a quasi-Gaussian waveform signal with amplitude proportional to energy of the gamma rays; a digital multichannel analyzer for processing the quasi-Gaussian waveform signal to produce a digital signal; and a wireless transceiver for transmitting the digital signal.

Preferably, the CdZnTe crystal is nested within a cylindrical collimator in such a manner that the rays can enter into the CdZnTe crystal through a ground-facing surface of the crystal.

The CdZnTe spectrometer further comprises a high voltage power supply that supplies a bias voltage to the CdZnTe crystal.

The aircraft comprises at least one of a navigation device, a range finder for measuring altitude information, or a video capture device.

The navigation device comprises at least one of a Beidou navigation device or a Global Positioning System (GPS) navigation device.

The aircraft further comprises a flight controller for controlling the flight of the aircraft, according to a preset flight route or flight instructions from the workstation system.

The workstation system comprises: a wireless transceiver for receiving the energy spectrum information from the CdZnTe spectrometer, and receiving at least one of the navigation information, altitude information, or a video image of an inspection area from the aircraft; a workstation for identifying nuclides, determining a type and intensity of a radioactive material and a dose rate of rays according to the energy spectrum information, drawing the radioactive material distribution profile and dose distribution profile in combination with the navigation information and altitude information from the aircraft, and overlaying the radioactive material distribution profile and the dose distribution profile on the video image of the inspection area; and a display for displaying the video image of the inspection area, the radioactive material distribution profile and the dose distribution profile, or the video image of the inspection area with the radioactive material distribution profile and the dose distribution profile overlaid on.

According to a second aspect of this disclosure, an aerial CdZnTe inspection method is provided, comprising: detecting radiation using a CdZnTe spectrometer, collecting an energy spectrum and transmitting energy spectrum information; flying an aircraft with the CdZnTe spectrometer for aerial inspection.

Flying an aircraft with the CdZnTe spectrometer for aerial inspection comprises: receiving, by a workstation system, energy spectrum information from the CdZnTe spectrometer, and determining radiation conditions by analyzing the energy spectrum information, for example, identifying nuclides, determining the type and intensity of a radioactive material, calculating a dose rate of the radiation and so on.

Flying an aircraft with the CdZnTe spectrometer for aerial inspection comprises: acquiring and transmitting, by the aircraft, at least one of navigation information, altitude information, a video image of an inspection area of the aircraft itself; drawing, by the workstation system, a three-dimensional radioactive material distribution profile and dose distribution profile according to the navigation information and altitude information from the aircraft and the energy spectrum information from the CdZnTe spectrometer, and overlaying the three-dimensional radioactive material distribution profile and dose distribution profile on the video image of the inspection area.

The method further comprises: controlling the flight, by the aircraft, according to a preset flight route or flight instructions from the workstation system.

According to the present disclosure, aerial inspection can be performed by an aircraft with a CdZnTe spectrometer, so that the work efficiency of nuclear radiation monitoring can be improved. In addition, the CdZnTe detector can operate at room temperature, and gain advantages in small size, light weight, high energy resolution, high detection efficiency, and good portability. In contrast to HPGe detectors, the CdZnTe detector has a large band gap and is operable at room temperature, without the need for large liquid nitrogen refrigeration equipment or electric refrigeration equipment, and can be made into portable detection equipment. In contrast to scintillator detectors, the CdZnTe detector can directly convert gamma rays or X-rays to electrical signals without the need for photomultiplier tubes or other optoelectronic transducers, and thus immune to magnetic and electric fields, with a smaller size, and lighter weight. Further, the CdZnTe detector can achieve higher energy resolution and thus more accurate nuclide identification compared with scintillator detectors. In contrast to the gas detectors, the CdZnTe detector has advantages in higher density, higher gamma ray detection efficiency, higher energy resolution, and infinite service life.

Further, since the processes of receiving energy spectrum information from the CdZnTe spectrometer, analyzing the energy spectrum information, identifying nuclides, determining the type and intensity of a radioactive material, and calculating a dose rate of rays are performed by the workstation, the endurance of the aircraft can be increased. Furthermore, the workstation system can draw a three-dimensional radioactive material distribution profile and dose distribution profile according to the navigation information and altitude information from the aircraft, and can overlay the three-dimensional radioactive material distribution profile and dose distribution profile on the video image from aircraft to reflect radiation conditions of the inspection area more intuitively.

Other features and advantages of the present disclosure will become apparent from the following detailed description of exemplary embodiments of the present disclosure with reference to the accompanying drawings.

### BRIEF DESCRIPTION OF THE DRAWINGS

In order to more clearly explain the embodiments of the present disclosure or the technical solutions in the prior art, a brief introduction will be given below for the drawings required to be used in the description of the embodiments or the prior art. It is obvious that, the drawings illustrated as follows are merely some of the embodiments of the present disclosure. A person skilled in the art may also acquire other drawings according to such drawings on the premise that no inventive effort is involved.

FIG. 1 is a structure diagram of an aerial CdZnTe inspection system (referred to as “inspection system”) according to an embodiment of the present disclosure;

FIG. 2 is a structure diagram of a CdZnTe spectrometer 10 according to an embodiment of the present disclosure;

FIG. 3 is a schematic view of a CdZnTe crystal 11 nested within a cylindrical collimator 17 of the present disclosure;

FIG. 4 is a structure diagram of an aircraft 20 according to an embodiment of the present disclosure;

FIG. 5 is a structure diagram of a workstation system 30 according to an embodiment of the present disclosure.

### DETAILED DESCRIPTION

Below, a clear and complete description will be given for the technical solution of embodiments of the present disclosure with reference to the figures of the embodiments.

The present disclosure is proposed in view of the problem of relatively low work efficiency of the traditional means for nuclear radiation monitoring.

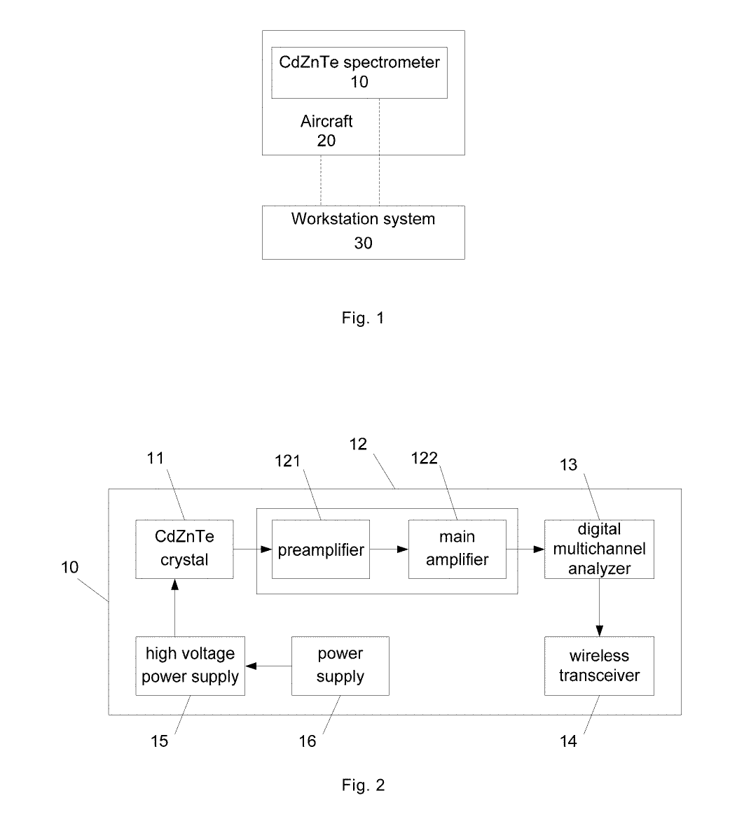

FIG. 1 is a structure diagram of an aerial CdZnTe inspection system (referred to as “inspection system”) according to an embodiment of the present disclosure.

As shown in FIG. 1, the inspection system comprises: a CdZnTe spectrometer 10 and an aircraft 20. The CdZnTe spectrometer 10 can detect radiation, such as Gamma rays or X-rays, collect an energy spectrum and transmit energy spectrum information. Through analyzing the energy spectrum information collected by the CdZnTe spectrometer, radiation conditions can be accurately determined, for example, the identification of the nuclides, the determination of the type and intensity of the radioactive material, the calculation of the dose rate of the rays, and the like. The aircraft 20 flies with a high energy resolution CdZnTe spectrometer 10 to perform aerial inspection, so that the work efficiency of nuclear radiation monitoring can be improved. In addition, the CdZnTe detector can operate at room temperature, and gain advantages in small size, light weight, high energy resolution, high detection efficiency, and good portability. In contrast to HPGe detectors, the CdZnTe detector has a large band gap and is operable at room temperature, without the need for large liquid nitrogen refrigeration equipment or electric refrigeration equipment, and can be made into portable detection equipment. In contrast to scintillator detectors, the CdZnTe detector can directly convert gamma rays or X-rays to electrical signals without the need for photomultiplier tubes or other optoelectronic transducers, and thus immune to magnetic and electric fields, with a smaller size, and lighter weight. Further, the CdZnTe detector can achieve higher energy resolution and thus more accurate nuclide identification compared with scintillator detectors. In contrast to the gas detectors, the CdZnTe detector has advantages in higher density, higher gamma ray detection efficiency, higher energy resolution, and infinite service life.

The CdZnTe spectrometer 10 has high energy resolution, small size, and light weight. Through combining the CdZnTe spectrometer into the aircraft 20, high measurement accuracy and long endurance can be obtained. The aircraft 20 can fly to the scene of a nuclear accident, inspect the accident scene, and provide support for rescue, thereby the radiation dose received by operators who otherwise must enter into the accident scene can be reduced.

Below, the process of analyzing the energy spectrum information collected by the CdZnTe spectrometer to identify nuclides, to determine the type and intensity of a radioactive material, and to calculate the dose rate of the radiation will be described. The following processes are performed on the collected energy spectrum: smoothing the energy spectrum, locating peaks, performing energy calibration, calculating energy calibration coefficients according to the equation E=a+bx+cx², wherein E is energy, a, b, c are coefficients, x is channel address, and calculating peak energy values. Candidate nuclides corresponding to the peak energy values are searched in a radionuclide database. The probability of occurrence of each candidate nuclide is calculated. Interfering candidate nuclides are excluded to obtain nuclides corresponding to the peaks, thereby determining the type of a radioactive material. A peak area for each peak in the energy spectrum is calculated. The intensity of the radioactive material is determined according to the peak energy value and the peak area. The dose rate of rays is D=ΣᵢⁿNᵢG(Eᵢ), wherein i is a channel address, n is a total number of channels of the energy spectrum, N, is a count rate in channel i, G(Eᵢ) is an energy spectrum dose conversion function, which is determined when the CdZnTe spectrometer is shipped from the factory. The dose rate of the radiation can be calculated in real time according to the collected energy spectrum and the G(E) function.

As shown in FIG. 1, the inspection system may further comprise a workstation system 30. The energy spectrum analysis process can be performed on the aircraft 20, or may be performed in the workstation system 30 on the ground. However, in order to increase the endurance of the aircraft 20, preferably, the energy spectrum analysis is performed in the workstation system 30. The workstation system 30 receives the energy spectrum information from the CdZnTe spectrometer 10 and performs analysis to identify nuclides, determines the type and intensity of a radioactive material, and calculates the dose rate of the rays.

The inspection system of the present disclosure may further draw a three-dimensional radioactive material distribution profile and a three-dimensional dose distribution profile. Further, the three-dimensional radioactive material distribution profile and dose distribution profile may be overlaid on a video image of the inspection area to reflect radiation conditions of the inspection area more intuitively. For this purpose, the aircraft 20 may acquire navigation information of the aircraft itself, altitude information, video image information of the inspection area and the like. A three-dimensional radioactive material distribution profile and dose distribution profile are drawn according to the navigation information, altitude information from the aircraft 20 and the energy spectrum information collected by the CdZnTe spectrometer 10. In a case of further capturing a video image of the inspection area by the aircraft 20, the three-dimensional radioactive material distribution profile and dose distribution profile may be further overlaid on the video image of the inspection area.

The above process of drawing a three-dimensional radioactive material distribution profile and dose distribution profile and overlaying the profile on the video image can be performed on the aircraft 20, or may be performed in the workstation system 30. However, in order to increase the endurance of the aircraft 20, preferably, the process of drawing a three-dimensional radioactive material and dose distribution profile and overlaying the profile on the video image may be performed in the workstation system 30. The workstation system 30 receives the navigation information, altitude information, and the video image information from the aircraft 20, and draws the three-dimensional radioactive material and dose distribution profile according to the navigation information, altitude information sent by the aircraft 20 and the energy spectrum information sent by the CdZnTe spectrometer 10. If a video image of the inspection area is available, the three-dimensional radioactive material and dose distribution profile may be further overlaid on the video image of the inspection area.

FIG. 2 is a structure diagram of a CdZnTe spectrometer 10 according to an embodiment of the present disclosure.

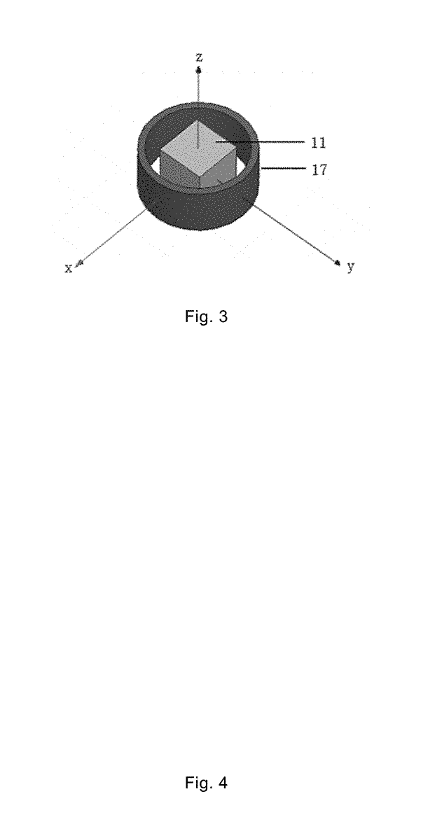

As shown in FIG. 2, the CdZnTe spectrometer 10 comprises: a CdZnTe crystal 11, an amplifier 12, a digital multichannel analyzer 13 and a wireless transceiver 14. The CdZnTe crystal 11 converts incident gamma rays into an electrical signal. The amplifier 21 processes the electrical signal to produce a quasi-Gaussian signal with amplitude proportional to the energy of the incident gamma rays. The digital multichannel analyzer 13 processes the quasi-Gaussian waveform signal to produce a digital signal. The digital signal is transmitted by the wireless transceiver 14. As shown in FIG. 2, the CdZnTe spectrometer 10 further comprises a high voltage power supply 15 for supplying a bias voltage to the CdZnTe crystal 11, and a power supply 16 for supplying power to all electric components in the CdZnTe spectrometer 10. The CdZnTe crystal 11 is a room temperature semiconductor material with a band gap width of 1.57 eV, a density of 5.78 g/cm3 and an average atomic number of 49.1. Preferably, as shown in FIG. 3, the CdZnTe crystal 11 is nested within a cylindrical collimator 17 in such a manner that the rays can enter into the CdZnTe crystal through a ground-facing surface of the crystal, and rays in other directions are prevented from entering the CdZnTe crystal, making the measurement result more accurate. Preferably, the amplifier 12 comprises a preamplifier 121 and a main amplifier 122. The preamplifier 121 may be a charge-sensitive preamplifier.

FIG. 4 is a structure diagram of an aircraft 20 according to an embodiment of the present disclosure. The aircraft 20 may be, for example, a drone, a multi-axis aircraft, or other remote control aircraft.

As shown in FIG. 4, the aircraft 20 comprises a navigation device 21, a range finder 22 for measuring altitude information, and a video capture device 23. The aircraft 20 may further comprise a flight controller 24, a wireless transceiver 25, a power supply 26 and other components. The navigation device 21 comprises a Beidou navigation device 211 and/or a Global Positioning System (GPS) navigation device 212. Both of the Beidou navigation device 211 and GPS navigation device 212 can provide latitude, longitude and altitude information to supply dual-mode navigation for the aircraft 20. The use of the Beidou navigation 211 can protect data from being leaked when inspecting nuclear facilities and retired nuclear sites. The range finder 22 is a laser range finder or an ultrasonic range finder that measures the altitude of the aircraft 20. The video capture device 23 may be a CCD or a CMOS camera for obtaining a video image of the inspection area. The flight controller 24 can receive flight instructions issued by the workstation 30 via the wireless transceiver 2, and can control the flight states of the aircraft 20 according to the flight instructions, such as the flight direction, flight altitude, flight distance, flight time, hovering time and the like, or the flight controller 24 may control the aircraft 20 according to a preset flight route. The navigation information, video image, altitude information are transmitted by the wireless transceiver 25. The power supply 26 may supply power to all electric components 21-25 of the aircraft 20.

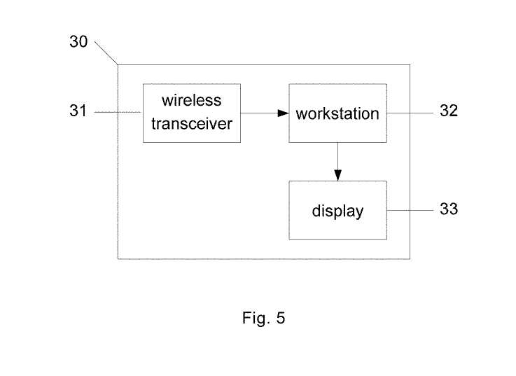

FIG. 5 is a structure diagram of a workstation system 30 according to an embodiment of the present disclosure.

As shown in FIG. 5, the workstation system 30 comprises: a wireless transceiver 31, a workstation 32 and a display 33. The wireless transceiver 31 is used for receiving and transmitting signals. For example, in one aspect, the wireless transceiver 31 receives energy spectrum information from the CdZnTe spectrometer 10 and the navigation information, altitude information, and video image information of the inspection area from the aircraft 20. In another aspect, the wireless transceiver 31 transmits flight instructions to the aircraft 20 to control the aircraft 20. The workstation 32 is used for performing data calculation and processing operations, for example, identifying nuclides according to the spectrum information, determining the type and intensity of a radioactive material, calculating the dose rate of rays, and drawing a three-dimensional radioactive material distribution profile and dose distribution profile in combination with the navigation information and altitude information sent by the aircraft 20, and overlaying the three-dimensional radioactive material and dose distribution profile on the video image of the inspection area. The display 33 is used for, for example, displaying the video image of the inspection area, the three-dimensional radioactive material and dose distribution profile, or the video image of the inspection area on which the three-dimensional radioactive material and dose distribution profile is overlaid.

An aerial CdZnTe inspection method is further provided in the present disclosure, comprising: detecting radiation using a CdZnTe spectrometer 10, collecting an energy spectrum and transmitting energy spectrum information; flying an aircraft 20 with the CdZnTe spectrometer 10 for aerial inspection.

The workstation system 30 may receive energy spectrum information from the CdZnTe spectrometer 10, and determine radiation conditions by analyzing the energy spectrum information, for example, the identification of the nuclide, the determination of the type and intensity of the radioactive material, the calculation of the dose rate of rays, and the like.

Flight control is performed on the aircraft 20 according to flight instructions issued by the workstation system 30, or flight control is performed on the aircraft 20 according to a preset flight route.

Besides, the aircraft 20 may further transmit at least one of navigation information, altitude information, and a video image of an inspection area of the aircraft itself. The workstation system 30 draws a three-dimensional radioactive material distribution profile and dose distribution profile according to the navigation information and altitude information from the aircraft 20 and the energy spectrum information from the CdZnTe spectrometer 10, and overlays the three-dimensional radioactive material distribution profile and dose distribution profile on the video image of the inspection area.

A person skilled in the art can understand that all or part of the steps for carrying out the method in the above embodiments can be completed by hardware or a program instructing the related hardware, wherein the program can be stored in a computer readable storage medium. The storage medium may be a read-only memory (ROM), a magnetic disk or a compact disk (CD).

The above is merely preferred embodiments of this disclosure, and is not limitation to this disclosure. Within spirit and principles of this utility model, any modification, replacement, improvement and etc shall be contained in the protection scope of this disclosure.

1-2. (canceled)

3. An aerial CdZnTe inspection system, comprising:
a CdZnTe spectrometer for detecting rays and transmitting energy spectrum information of the rays;
an aircraft for flying with the CdZnTe spectrometer to perform aerial inspection, and transmitting navigation information, altitude information, and a video image of an inspection area of the aircraft; and
a workstation system for drawing a three-dimensional radioactive material distribution profile and a three-dimensional dose distribution profile according to the navigation information and altitude information from the aircraft and the energy spectrum information from the CdZnTe spectrometer, and overlaying the radioactive material distribution profile and the dose distribution profile on the video image of the inspection area.

4. The aerial CdZnTe inspection system according to claim 3, wherein the CdZnTe spectrometer comprises:
a CdZnTe crystal for converting incident gamma rays into an electrical signal;
an amplifier for processing the electrical signal to produce a quasi-Gaussian waveform signal with amplitude proportional to energy of the gamma rays;
a digital multichannel analyzer for processing the quasi-Gaussian waveform signal to produce a digital signal; and
a wireless transceiver for transmitting the digital signal.

5. The aerial CdZnTe inspection system according to claim 4, wherein the CdZnTe crystal is nested within a cylindrical collimator in such a manner that the rays can enter into the CdZnTe crystal through a ground-facing surface of the crystal.

6. The aerial CdZnTe inspection system according to claim 4, wherein the CdZnTe spectrometer further comprises a high voltage power supply that supplies a bias voltage to the CdZnTe crystal.

7. The aerial CdZnTe inspection system according to claim 3, wherein the aircraft comprises a navigation device, a range finder for measuring altitude information, and a video capture device.

8. The aerial CdZnTe inspection system according to claim 7, wherein the navigation device comprises at least one of a Beidou navigation device or a Global Positioning System (GPS) navigation device.

9. The aerial CdZnTe inspection system according to claim 7, wherein the aircraft further comprises:
a flight controller for controlling the flight of the aircraft, according to a preset flight route or flight instructions from the workstation system.

10. The aerial CdZnTe inspection system according to claim 3, wherein the workstation system comprises:
a wireless transceiver for receiving the energy spectrum information from the CdZnTe spectrometer, and receiving the navigation information, altitude information, and a video image of an inspection area from the aircraft;
a workstation for identifying nuclides, determining a type and intensity of a radioactive material and a dose rate of rays according to the energy spectrum information, drawing the radioactive material distribution profile according to the type and intensity of a radioactive material in combination with the navigation information and altitude information from the aircraft, drawing the dose distribution profile according to the dose rate of rays in combination with the navigation information and altitude information from the aircraft, and overlaying the radioactive material distribution profile and the dose distribution profile on the video image of the inspection area; and
a display for displaying the video image of the inspection area, the radioactive material distribution profile and the dose distribution profile, or the video image of the inspection area with the radioactive material distribution profile and the dose distribution profile overlaid on.

11-14. (canceled)

15. An aerial CdZnTe inspection method, comprising:
obtaining energy spectrum information of rays from a CdZnTe spectrometer;
obtaining navigation information, altitude information, a video image of an inspection area from an aircraft which is flying with the CdZnTe spectrometer to perform aerial inspection; and
drawing a three-dimensional radioactive material distribution profile and a three-dimensional dose distribution profile according to the navigation information and altitude information from the aircraft and the energy spectrum information from the CdZnTe spectrometer, and overlaying the radioactive material distribution profile and the dose distribution profile on the video image of the inspection area.

16. The aerial CdZnTe inspection method according to claim 15, wherein:
the radioactive material distribution profile is drawn according to the navigation information and altitude information from the aircraft in combination with a type and intensity of a radioactive material, which are determined from the energy spectrum information; and
the dose distribution profile is drawn according to the navigation information and altitude information from the aircraft in combination with a dose rate of rays, which are determined from the energy spectrum information.

17. An aerial CdZnTe inspection apparatus, comprising:
a memory; and
a processor coupled to the memory, wherein the processor is configured to perform the aerial CdZnTe inspection method of claim 15 based on instructions stored in the memory.

18. An aerial CdZnTe inspection apparatus, comprising:
a memory; and
a processor coupled to the memory, wherein the processor is configured to perform the aerial CdZnTe inspection method of claim 16 based on instructions stored in the memory.

19. A non-transitory computer-readable storage medium storing a computer program which implements the steps of the aerial CdZnTe inspection method of claim 15 when executed by a processor.

20. A non-transitory computer-readable storage medium storing a computer program which implements the steps of the aerial CdZnTe inspection method of claim 16 when executed by a processor. the aerial CdZnTe inspection method of claim 16 when executed by a processor.

21. An aerial CdZnTe inspection apparatus, comprising:
a first acquiring module for obtaining energy spectrum information of rays from a CdZnTe spectrometer;
a second acquiring module for obtaining navigation information, altitude information, a video image of an inspection area from a aircraft which is flying with the CdZnTe spectrometer to perform aerial inspection; and
an information processing module for drawing a three-dimensional radioactive material distribution profile and a three-dimensional dose distribution profile according to the navigation information and altitude information from the aircraft and the energy spectrum information from the CdZnTe spectrometer, and overlaying the radioactive material distribution profile and the dose distribution profile on the video image of the inspection area.

22. The aerial CdZnTe inspection apparatus according to claim 21, wherein:
the radioactive material distribution profile is drawn according to the navigation information and altitude information from the aircraft in combination with a type and intensity of a radioactive material, which are determined from the energy spectrum information; and
the dose distribution profile is drawn according to the navigation information and altitude information from the aircraft in combination with a dose rate of rays, which are determined from the energy spectrum information.
